(19) United States
(12) Patent Application Publication
(10) Pub. No.: US 2019/0360597 A1
(43) Pub. Date: Nov. 28, 2019

(54) SEALING DEVICE FOR BEARING HOUSING

(71) Applicant: NTN CORPORATION, Osaka (JP)

(72) Inventor: Yukihisa TSUMORI, Mie (JP)

(21) Appl. No.: 15/752,207

(22) PCT Filed: Jul. 29, 2016
(86) PCT No.: PCT/JP2016/072306

§ 371 Date: Feb. 12, 2018

(30) Foreign Application Priority Data
Aug. 12, 2015 (JP) 2015-159696
Aug. 12, 2015 (JP) 2015-159697

(51) Int. Cl. F16J 15/40; F16C 33/80; F16J 15/447; F16C 35/04

(52) U.S. Cl. CPC F16J 15/40; F16C 35/042; F16J 15/4476; F16C 33/80

(57) ABSTRACT

To provide a sealing device for a bearing housing capable of preventing or suppressing entering of dust into an inner sealed space of the bearing housing and into a sealing passage such as a labyrinth portion. A sealing device 1 for a bearing housing includes a fixed member 2 fixed to the bearing housing 12 in which a rolling bearing 13 that supports a rotation shaft 14 is arranged, a rotating member 3 fixed to the rotation shaft 14, and a labyrinth portion 4 formed by surfaces of the fixed member 2 and the rotating member 3 arranged to face each other with a gap. The labyrinth portion 4 is formed such that a gap width of an inlet portion 4a to an inner sealed space of the bearing housing 12 from an outside is smaller than a gap width of a portion other than the inlet portion. The labyrinth portion 4 includes an inclined space portion 4c that is not orthogonal to and is not parallel to the rotation shaft 14, at a region between a portion at a side of the inner sealed space and the inlet portion 4a.

### TECHNICAL FIELD

The present invention relates to a sealing device for a bearing housing (a plummer block) in which a self-aligning rolling bearing is arranged used for a general industrial machine.

### BACKGROUND ART

A bearing housing is called a bearing box or a plummer block, and the bearing housing is widely used for a general industrial machine as a bearing unit combined with a rolling bearing arranged in the bearing housing. Examples of the general industrial machine to which the bearing housing is applied, include vehicles, construction machines, machine tools, gear devices, conveyance devices, air conditioning facilities, mine facilities, power generation facilities in various fields. For example, in a mine, the plummer block that holds a bearing, which supports a rotational shaft of a conveyor roller at both sides of a belt conveyor that conveys iron ore or coal from a stope to a loading place to trucks, is used. Further, in an iron mill, the bearing housing is used in a bearing for a rolling mill roll neck.

In order to prevent dust or water from entering into an inner sealed space in which the rolling bearing is arranged and in order to prevent a lubricant from being leaked, a sealing device is adopted in the bearing housing. As the sealing device for the bearing housing, a contact seal such as a rubber seal, a felt seal, and a rubber seal with a spring, a labyrinth seal in which a small gap space is formed in a labyrinth manner, a grease seal filled with grease, or a seal structure combining several seals thereof is adopted in accordance with the usage. Especially, in an environment in which much fine dust is apt to be scattered such as in a mine, an iron mill and a power plant, or in an environment in which rain water or cooling water pours, a configuration of the sealing device is significant, and a seal having high sealing performance that combines a plurality kinds of seals is adopted.

Conventionally, Patent Document 1 proposes a sealing device for a bearing housing in such a usage. A configuration of the sealing device is described with reference to FIG. 7. FIG. 7 is a cross-sectional view of the sealing device. As shown in FIG. 7, a sealing device 21 is provided with a fixed member 22 fixed to a bearing housing 24, and a rotating member 23 fixed to a rotation shaft 25. A labyrinth portion 26 formed by surfaces of the fixed member 22 and the rotating member 23 arranged to face to each other with a gap, and a piston ring labyrinth portion 27 formed by two piston rings arranged at two parts are arranged in a sealing passage that connects an outside of the sealing device and an inner sealed space. Further, the sealing passage including the labyrinth portion 26 is filled with grease. With this configuration, dust 28 and water are prevented from entering into the inner sealed space of the bearing housing 24.

### PRIOR ART DOCUMENTS

### Patent Documents

Patent Document 1: U.S. Pat. No. 5,904,356 B

### SUMMARY OF THE INVENTION

### Problems to be Solved by the Invention

In the configuration shown in FIG. 7, a sealing passage space from an inlet portion 26a of the labyrinth portion 26 into which the dust 28 is entered firstly from the outside, to the piston ring labyrinth portion 27 has a substantially uniform width in a section over the whole range. In such a configuration, the dust 28 having a size approximate to the space volume of the inlet portion 26a enters into the sealing passage and reaches the piston ring of the piston ring labyrinth portion 27. Either or both of the rotating member 23 and the fixed member 22 are worn due to the dust entered into the sealing passage and retained between the rotating member 23 and the fixed member 22 forming the seal. As a result, a gap space of the labyrinth portion 26 is expanded, and therefore a function as a labyrinth seal might be deteriorated in long term use.

In a case in which many bearings are installed over along range, for example, in a mine or an iron mill, it is required to make a maintenance interval of the bearing unit as long as possible from a viewpoint of reducing a maintenance cost. Thus, it is required to eventually prevent the dust from entering into the inner sealed space of the bearing housing. Further, in order to avoid deterioration of sealing performance due to the wear of the members described above, it is also required to prevent the dust from entering into the sealing passage such as the labyrinth portion formed between the fixed member and the rotating member.

An object of the present invention is, in order to solve such a problem, to provide a sealing device for a bearing housing capable of preventing or suppressing entering of dust into an inner sealed space of the bearing housing and into a sealing passage such as a labyrinth portion.

### Means for Solving the Problem

A sealing device for a bearing housing of the present invention is formed as a sealing device for a bearing housing in which a rolling bearing that supports a rotation shaft is arranged. The sealing device includes a fixed member fixed to the bearing housing, a rotating member fixed to the rotation shaft, and a labyrinth portion formed by surfaces of the fixed member and the rotating member arranged to face each other with a gap. The labyrinth portion is formed such that a gap width of an inlet portion of the sealing device to an inner sealed space of the bearing housing from an outside is smaller than a gap width of a portion other than the inlet portion. The labyrinth portion includes an inclined space portion that is not orthogonal to and is not parallel to the rotation shaft in a region between a portion at a side of the inner sealed space and the inlet portion.

The sealing device includes, in a sealing passage at the side of the inner sealed space with respect to the labyrinth portion, a seal ring labyrinth portion formed by a gap between a seal ring fixed to the rotating member and the fixed member, and a grease seal portion formed by a space between the fixed member and the rotating member filled with grease, the space having a gap width larger than the gap width of the labyrinth portion. Further, the sealing device includes, in the sealing passage at the side of the inner sealed space with respect to the labyrinth portion, a contact seal portion formed by a felt or an O-ring.

The sealing device includes an oil supply plug, and a grease groove for transmitting the grease supplied from the oil supply plug to the labyrinth portion. The grease groove is connected to a portion adjacent to an end portion of the inclined space portion, at a side of the inlet portion.

The sealing device includes a bristle portion formed by fiber flocked on at least one of surfaces of the rotating member and the fixed member, the bristle portion being formed in at least a part of the labyrinth portion formed by the rotating member and the fixed member. Further, the bristle portion is formed at the inlet portion in the labyrinth portion.

The bristle portion is formed by fiber flocked on an outer surface of the fixed member around an inlet to the inner sealed space of the bearing housing from the outside.

Further, the fiber is formed of synthetic resin, and the bristle portion is formed as an electrostatically flocked portion.

### Effects of the Invention

The sealing device for the bearing housing of the present invention includes the fixed member fixed to the bearing housing, the rotating member fixed to the rotation shaft, and the labyrinth portion formed by the surfaces of the fixed member and the rotating member arranged to face each other with a gap. In the labyrinth portion, since the gap width of the inlet portion of the sealing device to the inner sealed space of the bearing housing from the outside is smaller than the gap width of the portion other than the inlet portion, a sectional area of the inlet portion of the labyrinth portion to which dust is entered firstly from the outside is smaller than a sectional area of an inner portion. Consequently, entering of dust can be suppressed, and even if the dust is entered, the dust can be restricted to small size dust. Further, volume (size) of the sealing device can be reduced.

Further, since the labyrinth portion includes the inclined space portion that is not orthogonal to and is not parallel to the rotation shaft in the region between the portion at the side of the inner sealed space and the inlet portion, a pressure difference from the inner side toward the outer side can be caused in the inclined space portion by centrifugal force generated by the rotating member and thereby entering of dust can be suppressed.

The sealing device includes, in the sealing passage at the side of the inner sealed space with respect to the labyrinth portion, the seal ring labyrinth portion formed by the gap between the seal ring fixed to the rotating member and the fixed member, and the grease seal portion formed by the space between the fixed member and the rotating member filled with grease, the space having the gap width larger than the gap width of the labyrinth portion, and thereby a sealing structure with high sealing performance can be obtained. Further, the sealing device includes, in the sealing passage at the side of the inner sealed space with respect to the labyrinth portion, the contact seal portion formed by a felt or an O-ring, and thereby fine dust entered into the inside can be firmly prevented from reaching the inner sealed space of the bearing housing.

The sealing device includes the oil supply plug, and the grease groove for transmitting the grease supplied from the oil supply plug to the labyrinth portion, and the grease groove is connected to the portion adjacent to the end portion of the inclined space portion, at the side of the inlet portion. Consequently, grease and dust are extruded toward the inlet portion from both of the side of the inclined space portion and the side of the grease groove, and thereby entering of the dust can be suppressed.

The sealing device includes the bristle portion formed by fiber flocked on at least one of the surfaces of the rotating member and the fixed member, the bristle portion being formed in at least a part of the labyrinth portion formed by the rotating member and the fixed member. Consequently, a foreign object such as dust is captured by the bristle portion and thereby entering of the dust into the inner sealed space of the bearing housing can be prevented.

The bristle portion is formed by fiber flocked on the outer surface of the fixed member around the inlet to the inner sealed space of the bearing housing from the outside, and thereby a foreign object such as dust is captured by the bristle portion around the inlet to an inside of the sealing passage, and entering of the dust to the inside of the sealing passage can be suppressed.

The fiber is formed of synthetic resin, and the bristle portion is formed as the electrostatically flocked portion, and thereby swelling or dissolving of the fiber is hardly caused by oil in the grease filled in the sealing passage, and the bristle portion which is chemically stable and has the fiber flocked densely with uniform quality can be obtained.

### BRIEF DESCRIPTION OF THE DRAWINGS

FIG. 1 illustrates a cross-sectional view of a sealing device for a bearing housing according to one example of the present invention.

FIG. 2 illustrates an enlarged view of a part of the sealing device for the bearing housing shown in FIG. 1.

FIG. 3 illustrates a cross-sectional view of the sealing device for the bearing housing according to other example of the present invention.

FIG. 4 illustrates a cross-sectional view of the sealing device for the bearing housing according to other example of the present invention.

FIG. 5 illustrates an enlarged view of a part of the sealing device for the bearing housing shown in FIG. 4.

FIG. 6 illustrates an example in which a bristle portion is formed around an inlet of a sealing passage.

FIG. 7 illustrating a cross-sectional view of a conventional sealing device for a bearing housing.

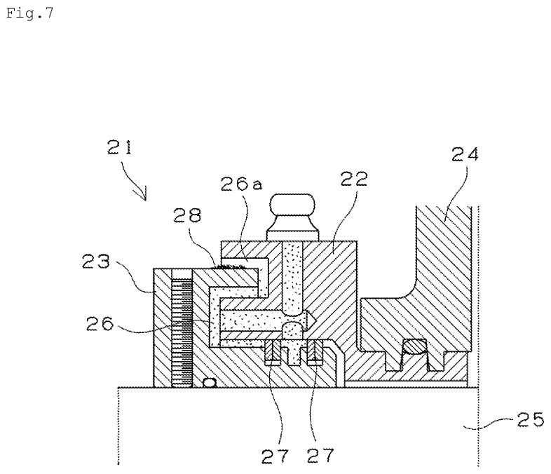

### MODE FOR CARRYING OUT THE INVENTION

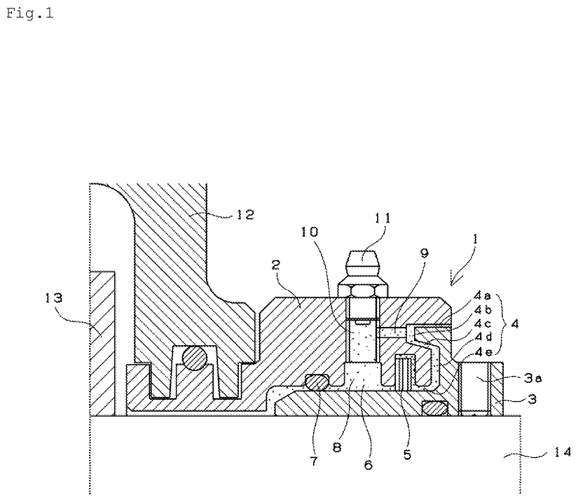

One example of a sealing device for a bearing housing of the present invention is described with reference to FIG. 1. FIG. 1 is a cross-sectional view of the sealing device. A rolling bearing 13 that supports a rotation shaft 14 is arranged inside a bearing housing 12. The rolling bearing 13 is not especially limited, and therefore a self-aligning ball bearing, a ball bearing or a roller bearing may be adopted as the rolling bearing 13. A sealing device 1 for a bearing housing is provided with a fixed member 2 fixed to the bearing housing 12, and a rotating member 3 fixed to the rotation shaft 14. The rotating member 3 is firmly fixed to the rotation shaft 14 by a W-type setscrew 3a or the like. In this configuration, a sealing passage that connects an outside of the sealing device 1 for the bearing housing and an inner sealed space of the bearing housing 12 is formed between the fixed member 2 and the rotating member 3. In the sealing passage, (1) a labyrinth portion 4, (2) a seal ring labyrinth portion 5, (3) a grease seal portion 6, and (4) a contact seal portion 7 are formed. In the present invention, especially, (1) the labyrinth portion 4 has a characteristic configuration. The sealing passage is filled with grease 8. The sealing device 1 for the bearing housing includes an oil supply plug 11 at an upper part of the fixed member 2. The oil supply plug 11 is opened regularly to supply the grease 8 to the sealing passage via a grease hole 10 and a grease groove 9. Hereinafter, each of configurations of the seal portions (1) to (4) is described.

### (1) Labyrinth Portion

The labyrinth portion 4 is formed by a recessed surface and a projection surface of the fixed member 2 and the rotating member 3 arranged to face to each other with a gap. That is, the fixed member 2 and the rotating member 3 are positioned such that a projection of one member and a recess of another member are complementarily arranged with a gap. The labyrinth portion 4 is arranged at an outermost side of the sealing device 1 for the bearing housing in the sealing passage. An inlet portion 4a of the labyrinth portion 4 is formed as an inlet from an outside to the inner sealed space of the bearing housing 12 sealed by the sealing device 1 for the bearing housing.

The labyrinth portion 4 is formed by the inlet portion 4a as a first region, a second region 4b, an inclined space portion 4c as a third region, a fourth region 4d, and a fifth region 4e arranged in this order from a side of the inlet. Each of the inlet portion 4a as the first region and the fifth region 4e is formed as a gap space parallel to the rotation shaft 14. By forming the inlet portion 4a to be a horizontal gap space, rain water or the like is hardly entered. Each of the second region 4b and the fourth region 4d is formed as a gap space orthogonal to the rotation shaft 14. The inclined space portion 4c as the third region is a gap space that is not orthogonal and is not parallel to the rotation shaft 14. A gap width (a gap width in a radial direction) of each of the inlet portion 4a as the first region, the inclined space portion 4c as the third region, and the fifth region 4e is set to be smaller than a gap width (a gap width in an axial direction) of each of the second region 4b and the fourth region 4d.

The gap width of the inlet portion 4a as the first region is set to be smaller than a gap width of other regions in the labyrinth portion 4. The gap width is defined by a distance between surfaces of the fixed member 2 and the rotating member 3 in each region. A sectional area of the gap space having a small gap width is small. Accordingly, the sectional area of the gap space of the inlet portion 4a is smaller than the sectional area of the gap space of other region. With this, dust is hardly entered into the inlet portion 4a of the labyrinth portion 4, which is a part into which the dust is firstly entered from the outside, and even if the dust is entered into the inlet portion 4a, the dust can be restricted to small size dust. Further, a lubricant such as grease filled in the sealing passage is prevented from leaking from the inlet portion 4a.

A shape of the labyrinth portion 4 is not especially limited as long as a region having a small gap width with a resistance against a passing object such as grease and dust being large enough to suppress leaking of grease and entering of dust is arranged. As shown in FIG. 1, a shape in which a region having a small gap width and a region having a large gap width are alternately arranged is preferably adopted. By arranging the region having a large gap width at a plurality of positions, a speed of the passing object is gradually decreased and therefore the leaking of grease and the entering of dust can be further suppressed. Further, in a case in which the sealing passage is filled with grease, since the grease has a thixotropic property, large shearing force is applied to the grease in the region having the small gap width, and therefore excellent lubricating performance can be obtained, and the grease is in a semisolid state in the region having the large gap width, and therefore excellent sealing performance can be obtained.

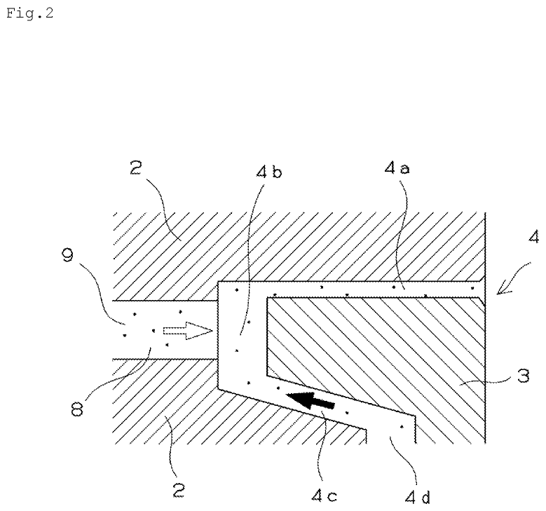

An effect of the inclined space portion 4c in the labyrinth portion 4 is described with reference to FIG. 2. FIG. 2 is an enlarged view of and around the inclined space portion of FIG. 1. As described above, in the labyrinth portion 4, the inclined space portion 4c as the third region is formed as a gap space not orthogonal and not parallel to the rotation shaft 14. Specifically, the inclined space portion 4c is inclined to be far away from the rotation shaft from a side of the fourth region 4d toward a side of the second region 4b. A pressure difference from the side of the fourth region 4d (inner side) toward the side of the second region 4b (outer side) is caused by centrifugal force generated by the rotating member 3. With this, when the rotating member 3 is rotated, force to extrude the grease and the dust along an incline of the inclined space portion 4c from the side of the fourth region 4d is generated (a black arrow in the figure).

An inclined angle of the inclined space portion 4c against a direction of the rotation shaft is not especially limited, however in order to generate the effect described above and to ensure sealing performance, the inclined angle is set in a range between 3° and 60°, more preferably a range between 40° and 50°.

Further, the grease groove 9 is formed parallel to the rotation shaft so as to be connected to a grease hole (see FIG. 1). The grease groove 9 is connected to the second region 4b adjacent to an end portion of the inclined space portion 4c at a side of the inlet portion 4a. The grease groove 9 is formed to extrude and supply the grease 8 from a side of the groove toward a side of the second region 4b (a while arrow in the figure). With this, extruding force toward the side of the inlet is applied to the second region 4b and the inlet portion 4a as the first region of the labyrinth portion 4 from substantially the same position along two directions, and thereby entering of the dust can be effectively suppressed. Further, this extruding force also fills the grease 8 sufficiently into the inlet portion 4a having a small gap width smaller than a normal part.

### (2) Seal Ring Labyrinth Portion

As shown in FIG. 1, the seal ring labyrinth portion 5 is arranged in the sealing passage at a side of the inner sealed space of the bearing housing 12 with respect to the labyrinth portion 4. The seal ring labyrinth portion 5 is formed by a gap between a seal ring fixed to the rotating member 3 and the fixed member 2. For example, the seal ring for a labyrinth is formed such that one end of each of the rings forming the seal ring contacts with either of the fixed member and the rotating member, and another end forms a labyrinth groove. The material of the seal ring is not especially limited, and for example, spring steel may be adopted. Further, a shape of the seal ring is not especially limited, and a known ring such as a single ring and a double ring can be used as the labyrinth ring.

### (3) Grease Seal Portion

As shown in FIG. 1, the grease seal portion 6 is formed by a space between the fixed member 2 and the rotating member 3 filled with the grease 8, the space having a gap width larger than that of the labyrinth portion 4. The grease seal portion 6 is directly connected to the grease hole 10, and when the grease 8 is supplied from the oil supply plug 11, a sufficient amount of grease is retained to keep excellent sealing performance.

### (4) Contact Seal Portion

As shown in FIG. 1, the contact seal portion 7 is arranged in the sealing passage at the side of the inner sealed space of the bearing housing 12 with respect to the labyrinth portion 4. The contact seal portion 7 is formed by a felt or an O-ring contacted with both of the fixed member 2 and the rotating member 3. The O-ring may be formed by a rubber seal ring formed of nitrile rubber, acryl rubber, silicon rubber, or fluororubber. Further, the felt may be formed by a felt seal material having a uniform layer combining wool fiber or synthetic fiber. Further, in a case in which the felt is adopted, it is necessary to adopt grease lubrication.

Each of (1) the labyrinth portion, (2) the seal ring labyrinth portion, and (3) the grease seal portion is formed as a non-contact seal portion. A combination of these seal portions (1) to (3) can ensure excellent sealing performance and therefore entering of dust or the like can be suppressed. In a case in which sufficient sealing performance can be ensured by this combination, (4) the contact seal portion can be omitted.

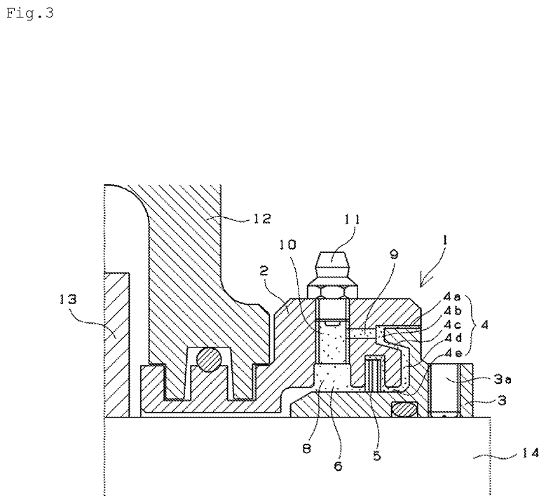

Other example of the sealing device for the bearing housing of the present invention is described with reference to FIG. 3. FIG. 3 is a cross-sectional view of the sealing device. A sealing device 1 for a bearing housing according to this example is provided with a fixed member 2 fixed to a bearing housing 12, and a rotating member 3 fixed to a rotation shaft 14. In this configuration, a sealing passage that connects an outside of the sealing device 1 for the bearing housing and an inner sealed space of the bearing housing 12 is formed between the fixed member 2 and the rotating member 3. In the sealing passage, (1) a labyrinth portion 4, (2) a seal ring labyrinth portion 5, and (3) a grease seal portion 6 are formed. That is, in this configuration, the contact seal portion is omitted from the configuration shown in FIG. 1. The configurations of the seal portions (1) to (3) are similar to those shown in FIG. 1.

The sealing device for bearing housing of the present invention is mainly used to fill grease into the sealing passage in addition to the inside of the bearing housing as described above (grease lubrication). Oil lubrication may be adopted in accordance with a configuration of the bearing housing. Further, in a case in which the bearing housing is filled with the grease, an inside of a rolling bearing is filled with the grease in advance.

As base oil that forms the grease, any oil may be adopted as long as it is normally used for a plummer block. Examples of the base oil include a mineral oil such as a spindle oil, a machine oil and a turbine oil, a hydrocarbon-based synthetic oil such as a polybutene oil, a poly α-olefin oil, an alkylbenzene oil and an alkylnaphthalene oil, a natural oil and fat, a non-hydrocarbon-based synthetic oil such as a polyol ester oil, a phosphoric ester oil, a diester oil, a polyglycol oil, a silicon oil, a polyphenyl ether oil, an alkyldiphenyl ether oil and a fluorine oil. These lubricants may be used independently, or alternatively two or more of these lubricants may be used in combination. In a case in which the oil lubrication is adopted, the base oil is used as a lubricant.

Examples of thickener that forms the grease include metal soap-based thickener such as aluminum soap, lithium soap, sodium soap, lithium complex soap, calcium complex soap and aluminum complex soap, a urea compound such as a diurea compound (aliphatic diurea, alicyclic diurea, aromatic diurea or the like) and a polyurea compound, and fluororesin powder such as PTFE resin. These thickeners may be used independently, or alternatively two or more of these thickeners may be used in combination.

A known additive may be added to the lubricant as needed. Examples of the additive include an extreme pressure agent such as an organozinc compound and an organomolybdenum compound, an antioxidant such as an amine-based compound, a phenol-based compound and a sulfur-based compound, a friction suppressive agent such as a sulfur-based compound and a phosphorous-based compound, a rust preventive agent such as polyhydric alcohol ester, a viscosity index improver such as polymethacrylate and polystyrene, a solid lubricant such as molybdenum disulfide and graphite, and an oil agent such as ester and alcohol.

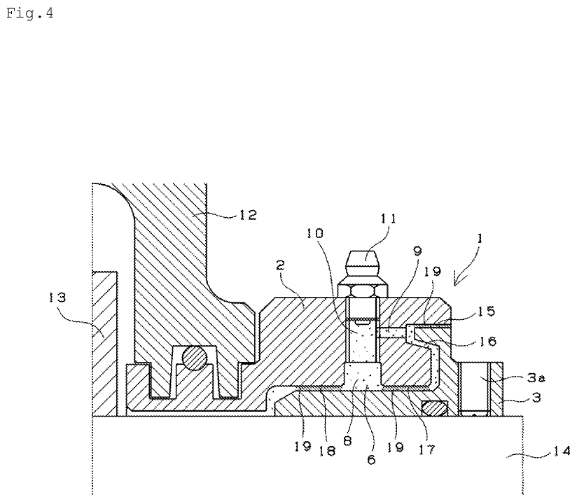

Other example of the sealing device for the bearing housing of the present invention is described with reference to FIG. 4. FIG. 4 is a cross-sectional view of the sealing device in which a bristle portion is formed in a labyrinth portion. A rolling bearing 13 that supports a rotation shaft 14 is arranged inside a bearing housing 12. A sealing device 1 for the bearing housing is provided with a fixed member 2 fixed to the bearing housing 12, and a rotating member 3 fixed to the rotation shaft 14, and therefore a configuration of the sealing device 1 for the bearing housing is similar to the configuration shown in FIG. 1. In this configuration, a sealing passage that connects an outside of the sealing device 1 for the bearing housing and an inner sealed space of the bearing housing 12 is formed between the fixed member 2 and the rotating member 3. In the sealing passage, labyrinth portions 15 to 18 and a grease seal portion 6 are formed. Further, similar to the configuration shown in FIG. 1, grease 8 is supplied to the sealing passage and therefore the sealing passage is filled with the grease 8.

The labyrinth portion 15 is arranged in the sealing passage at an outermost side of the sealing device 1 for the bearing housing among the labyrinth portions 15 to 18. The labyrinth portion 15 is formed as an inlet from an outside to the inner sealed space of the bearing housing 12 sealed by the sealing device 1 for the bearing housing. The labyrinth portions 17 and 18 are arranged in the sealing passage at both ends of the grease seal portion 6 respectively. The labyrinth portion 16 is a gap space not orthogonal and not parallel to the rotation shaft 16 (inclined space portion, corresponding to the inclined space portion 4c in FIG. 1).

In a case in which the bristle portion is formed, a sealing structure formed by the labyrinth portion is not especially limited as long as a region having a small gap width with a resistance against a passing object such as grease and dust being large enough to suppress leaking of grease and entering of dust is arranged. As shown in FIG. 4, a shape in which a region having a small gap width and a region having a large gap width are alternately arranged is preferably adopted (similar to the shapes shown in FIG. 1 and FIG. 3). The sealing effect or the like due to the labyrinth portion is similar to the configuration shown in FIG. 1 or the like.

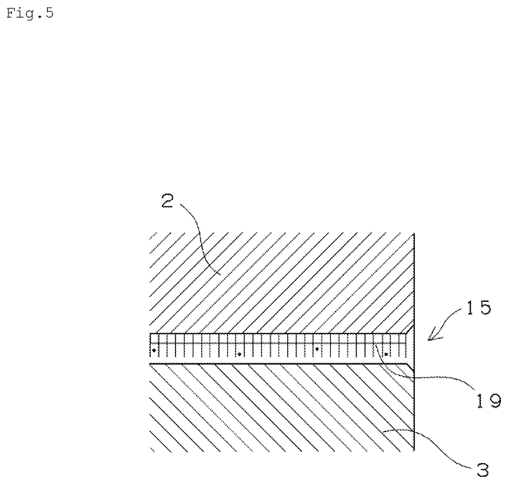

In this configuration, a bristle portion 19 is formed in the labyrinth portions 15, 17 and 18. A configuration of the bristle portion 19 is described with reference to FIG. 5. FIG. 5 is an enlarged view of the labyrinth portion 15 shown in FIG. 4. As shown in FIG. 5, in the labyrinth portion 15, the bristle portion 19 formed by fiber flocked on a surface of the fixed member 2 forming the labyrinth portion is formed. Here, the bristle portion 19 may be formed at least one of the rotating member 3 and the fixed member 2. That is, the bristle portion may be formed on only the fixed member, on only the rotating member, or on both of them. Among these, as shown in FIG. 4 and FIG. 5, it is preferable that the bristle portion is formed on the surface of the fixed member and the bristle portion is not formed on a surface of the rotating member. This is because the bristle portion formed on the surface of the rotating member might be dropped off due to the centrifugal force caused by the rotation of the rotating member, while the bristle portion formed on the surface of the fixed member can be stably retained on the surface because an influence of the centrifugal force of the rotating member is small. The labyrinth portion 15 is described above, and further the bristle portion is formed similarly in the labyrinth portions 17 and 18.

In the configuration shown in FIG. 4, the bristle portion is not formed in the labyrinth portion 16. As described above, the labyrinth portion 16 is formed as a gap space not orthogonal and not parallel to the rotation shaft 16. Specifically, the labyrinth portion 16 is inclined far away from the rotation shaft from a lower side of the figure toward an upper side of the figure. A pressure difference from an inner side toward an outer side can be caused by the centrifugal force generated by the rotating member 3. With this, when the rotating member 3 is rotated, force to extrude the grease and the dust along an incline of the labyrinth portion 16 from the inner side toward the outer side is generated.

Further, the bristle portion may be formed in the labyrinth portion 16 similar to other labyrinth portions. It may be determined as needed that the bristle portion is formed in any labyrinth portions 15 to 18, however it is preferable that the bristle portion is formed in at least the labyrinth portion 15. As described above, the labyrinth portion 15 is formed as an inlet toward the inner sealed space of the bearing housing 12 from the outside, and therefore by forming the bristle portion in the labyrinth portion 15, the entering of dust from the outside to an inside of the sealing passage is suppressed.

Further, in FIG. 4, a grease groove 9 is formed parallel to the rotation shaft 14 so as to be connected to a grease hole 10. The grease groove 9 is connected a portion adjacent to an end portion of the labyrinth portion 16 at an outer side and a portion adjacent to an end portion of the labyrinth portion 15 at an inner side, and therefore the grease 8 is extruded and supplied toward the labyrinth portion from a side of the groove. In addition, since extruding force from the side of the labyrinth portion 16 is applied to the labyrinth portion 15 as described above, the extruding force is applied toward the inlet side from substantially the same position along two directions, and thereby the entering of dust is effectively suppressed. Further, this extruding force also fills the grease 8 sufficiently into the labyrinth portion 15 in which the bristle portion is formed.

The bristle portion is formed by flocking short fiber. As a flocking method, a spraying method or an electrostatic flocking method may be adopted. The electrostatic flocking method is preferable because much fiber can be flocked vertically and densely in a short period of time even on a peripheral surface such as a surface of each member forming the labyrinth portion. As the electrostatic flocking method, a known method can be adopted, and for example a method in which coating a region to which the electrostatic flocking is applied with an adhesive, charging the short fiber, flocking short fiber approximately vertically on a surface coated by the adhesive by using electrostatic force, and then performing a drying step and a finishing step is adopted.

The short fiber used for flocking is not especially limited as long as it can be used as short fiber for flocking. Examples of the short fiber include (1) synthetic resin fiber formed of a polyolefin resin such as a polystyrene and a polypropylene, a polyamide resin such as a nylon, an aromatic polyamide resin, a polyester resin such as a polyethylene terephthalate, a polyethylene naphthalate, a polybutylene succinate, a polybutylene terephthalate, an acryl resin, a vinyl chloride, or a vinylon, (2) inorganic fiber such as carbon fiber and glass fiber, (3) regenerated fiber such as rayon and acetate, and natural fiber such as cotton, silk, hemp and wool. These fibers may be used independently, or alternatively two or more of these fibers may be used in combination. It is preferable to adopt the synthetic resin fiber among those fibers because the synthetic resin fiber is chemically stable, swelling or dissolving of the fiber is hardly caused by oil in the grease filled in the sealing passage, and fiber having uniform quality can be mass-produced and obtained at low cost.

A shape of the short fiber is not especially limited unless any negative influence affects sealing performance and bearing performance (torque or the like). For example, the fiber having a length of 0.3 mm to 2.0 mm and a thickness of 0.5 dtex to 50 dtex is preferable. The density of the short fiber in the bristle portion is preferably set in a range between 10% and 30% which is a ratio of the fiber against a flocked area. The length of the short fiber is set to be equal to or less than the gap width of the labyrinth portion in which the short fiber is arranged. Examples of a shape of the short fiber include a straight shape and a bent shape (a shape having a bent distal end), and examples of a sectional shape include a circular shape and a polygonal shape. It is preferable to adopt the short fiber having a polygonal section because a surface area thereof is larger than that of the short fiber having a circular section.

An adhesive including a urethane resin, an epoxy resin, an acryl resin, a vinyl acetate resin, a polyimide resin or a silicon resin as a main component may be adopted. Examples of the adhesive include a urethane resin solvent-based adhesive, an epoxy resin solvent-based adhesive, a vinyl acetate resin solvent-based adhesive, an acrylic resin-based emulsion adhesive, an acrylic ester-vinyl acetate copolymer emulsion adhesive, a vinyl acetate-based emulsion adhesive, a urethane resin-based emulsion adhesive, an epoxy resin-based emulsion adhesive, a polyester-based emulsion adhesive, an ethylene-vinyl acetate copolymer-based adhesive. These adhesives may be used independently, or alternatively two or more of these adhesives may be used in combination.

As shown in FIG. 4, the grease seal portion 6 is formed by a space filled with the grease 8 between the fixed member 2 and the rotating member 3, the space having the gap width larger than that of each labyrinth portion. The grease seal portion 6 is directly connected to the grease hole 10, and by supplying the grease 8 from the oil supply plug 11, a sufficient amount of grease is retained to keep excellent sealing performance of the grease seal portion 6. Also in the configuration in which the bristle portion is formed, the seal ring labyrinth portion using the labyrinth ring (seal ring) or the contact seal portion using the rubber seal, the felt seal or the rubber seal with the spring may be arranged as needed.

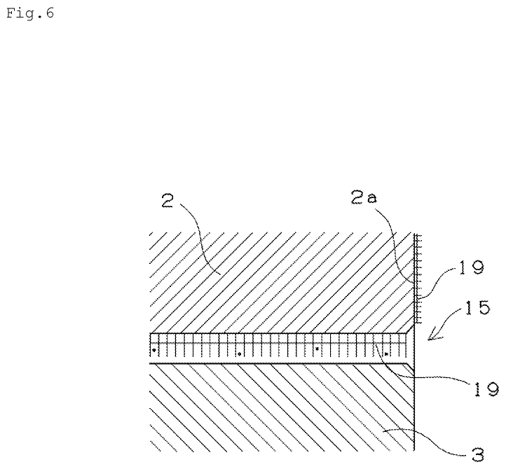

Another example of the sealing device for the bearing housing of the present invention is described with reference to FIG. 6. FIG. 6 is an enlarged cross-sectional view (the same region as FIG. 5) of the sealing device. A whole configuration of the sealing device for the bearing housing according to this example is similar to the configuration shown in FIG. 4. In the sealing device for the bearing housing, a bristle portion 19 is formed by fiber flocked on an outer surface 2a of a fixed member 2 around an inlet (around the inlet toward a labyrinth portion 15) to an inner sealed space of a bearing housing from an outside. A detail configuration of the bristle portion 19 is similar to that formed in the labyrinth portion described above. A foreign object such as dust is captured by the bristle portion 19 on the outer surface 2a, and thereby entering of the dust into the inside of the sealing passage can be suppressed. Further, the bristle portion may be also formed on an outer surface of a rotating member 3 around the inlet described above.

The sealing device for the bearing housing of the present invention is mainly used to fill grease into the sealing passage in addition to the inside of the bearing housing as described above (grease lubrication). A kind of grease used in the sealing device is described above. In a case in which the bearing housing is filled with the grease, an inside of a rolling bearing is filled with the grease in advance. Further, oil lubrication may be adopted in accordance with a configuration of the bearing housing. Especially in a case in which the oil lubrication is adopted in a configuration in which the bristle portion is formed, the oil is apt to be retained by the bristle portion in the labyrinth portion, and thereby excellent lubricating performance is obtained.

### INDUSTRIAL APPLICABILITY

The sealing device for the bearing housing of the present invention can prevent or suppress entering of dust into the inner sealed space of the bearing housing and into the sealing passage such as the labyrinth portion. Therefore, the sealing device for bearing housing of the present invention can be preferably used as a sealing device in a general industrial machine, especially in an environment in which much fine dust is apt to be scattered such as in a mine, an iron mill and a power plant, or in an environment in which rainwater or cooling water pours.

### REFERENCE SIGNS LIST

1: sealing device for bearing housing
2: fixed member
3: rotating member
4: labyrinth portion
5: seal ring labyrinth portion
6: grease seal portion
7: contact seal portion
8: grease
9: grease groove
10: grease hole
11: oil supply plug
12: bearing housing
13: rolling bearing
14: rotation shaft
15 to 18: labyrinth portions
19: bristle portion

1. A sealing device for a bearing housing in which a rolling bearing that supports a rotation shaft is arranged, the sealing device comprising:
a fixed member fixed to the bearing housing;
a rotating member fixed to the rotation shaft; and
a labyrinth portion formed by surfaces of the fixed member and the rotating member arranged to face each other with a gap,
wherein:
the labyrinth portion is formed such that a gap width of an inlet portion of the sealing device to an inner sealed space of the bearing housing from an outside is smaller than a gap width of a portion other than the inlet portion; and
the labyrinth portion comprises an inclined space portion that is not orthogonal to and is not parallel to the rotation shaft in a region between a portion at a side of the inner sealed space and the inlet portion.

2. The sealing device for the bearing housing according to claim 1, further comprising, in a sealing passage at the side of the inner sealed space with respect to the labyrinth portion, a seal ring labyrinth portion formed by a gap between a seal ring fixed to the rotating member and the fixed member, and a grease seal portion formed by a space between the fixed member and the rotating member filled with grease, the space having a gap width larger than the gap width of the labyrinth portion.

3. The sealing device for the bearing housing according to claim 2, further comprising, in the sealing passage at the side of the inner sealed space with respect to the labyrinth portion, a contact seal portion formed by a felt or an O-ring.

4. The sealing device for the bearing housing according to claim 1, further comprising an oil supply plug, and a grease groove for transmitting the grease supplied from the oil supply plug to the labyrinth portion,
wherein the grease groove is connected to a portion adjacent to an end portion of the inclined space portion, at a side of the inlet portion.

5. The sealing device for the bearing housing according to claim 1, further comprising a bristle portion formed by fiber flocked on at least one of surfaces of the rotating member and the fixed member, the bristle portion being formed in at least a part of the labyrinth portion formed by the rotating member and the fixed member.

6. The sealing device for the bearing housing according to claim 5, wherein the bristle portion is formed at the inlet portion in the labyrinth portion.

7. The sealing device for the bearing housing according to claim 5, wherein the bristle portion is formed by fiber flocked on an outer surface of the fixed member around an inlet to the inner sealed space of the bearing housing from the outside.

8. The sealing device for the bearing housing according to claim 5, wherein the fiber is formed of synthetic resin, and the bristle portion is formed as an electrostatically flocked portion.
